(19) United States
(12) Patent Application Publication
(10) Pub. No.: US 2026/0011246 A1
(43) Pub. Date: Jan. 8, 2026

(54) MANAGEMENT APPARATUS, INFORMATION SYSTEM, AND INFORMATION PROCESSING METHOD

(71) Applicant: TOYOTA JIDOSHA KABUSHIKI KAISHA, Toyota-shi (JP)

(72) Inventors: Kazuya OKADA, Tokyo (JP); Naoya KANEKO, Tokyo (JP); Lei ZHONG, Tokyo (JP)

(73) Assignee: TOYOTA JIDOSHA KABUSHIKI KAISHA, Toyota-shi (JP)

(21) Appl. No.: 19/256,859

(22) Filed: Jul. 1, 2025

(30) Foreign Application Priority Data
Jul. 5, 2024 (JP) 2024-109257

(51) Int. Cl. G08G 1/16; G08G 1/01

(52) U.S. Cl. CPC G08G 1/164; G08G 1/0116; G08G 1/0133; G08G 1/0141; G08G 1/0145; G08G 1/166

(57) ABSTRACT

In the management apparatus, the controller acquires, in response to a request from an information processing apparatus connected to the network, movement information related to the movement of a plurality of vehicles in which any of the plurality of user devices included in a predetermined range exists in the vehicle. Further, the controller provides the acquired movement information to the information processing apparatus.

### CROSS REFERENCE TO THE RELATED APPLICATION

This application claims the benefit of Japanese Patent Application No. 2024-109257, filed on Jul. 5, 2024, which is hereby incorporated by reference herein in its entirety.

### BACKGROUND

### Technical Field

The present disclosure is a management apparatus, information system, and information processing method.

### Description of Related Art

Traditionally, Mobile edge computing or Multi-access Edge Computing (MEC) servers have been used to reduce traffic accidents. Then, it is proposed that the server transmits vehicle warning information to all non-OBU (non-on-board unit) in-vehicle terminals, OBU (on-board unit) devices, and the like that exist within a certain distance range around, based on the positioning point of the collision prediction vehicle in the vehicle warning information, (see Patent Literature 1 below).

In this technology, after the server acquires a plurality of vehicle information, the risk of collision between a plurality of vehicle information is predicted based on the acquired plurality of vehicle information and a preset collision algorithm. Then, if there is a risk of collision, the server generates vehicle warning information. Here, the vehicle information is considered to include vehicle speed information, body length information, vehicle body width information, and the like.

### CITATION LIST

### Patent Literature

Patent Literature 1: Japanese Patent Laid-Open 2023-529938
Patent Literature 2: Japanese Patent Laid-Open 2005-004542

### SUMMARY

However, in conventional technology, there is no limitation on the positioning point of the collision prediction vehicle. For this reason, conventional techniques target all vehicles connected to the network, including vehicles that are unlikely to be subject to processing, and the load on the server may increase.

The object of the present disclosure is to efficiently provide information on the movement of a vehicle subject to information processing.

In one aspect, the embodiment of the disclosure is exemplified by a management device including a controller. The controller acquires, in response to a request from an information processing apparatus connected to the network, movement information related to the movement of a plurality of vehicles in which any of the plurality of user devices within a predetermined range exists in the vehicle. Further, the controller provides the acquired movement information to the information processing apparatus.

Since the management apparatus targets the plurality of user devices within the predetermined range, it can efficiently provide information on the movement of the vehicle.

### BRIEF DESCRIPTION OF THE DRAWINGS

FIG. 1 is a diagram illustrating an information system of one embodiment.

FIG. 2 is a diagram illustrating components constituting a fifth-generation mobile communication system.

FIGS. 3A-3C are diagrams that indicates each database included in DB7.

FIG. 4 is a diagram illustrating the configuration of vehicle characteristic information.

FIG. 5 is a sequence diagram illustrating the processing of each component in an information system.

FIG. 6 is a flowchart illustrating details of a neighboring vehicle information prediction process and a prediction result notification process.

### DESCRIPTION OF THE EMBODIMENTS

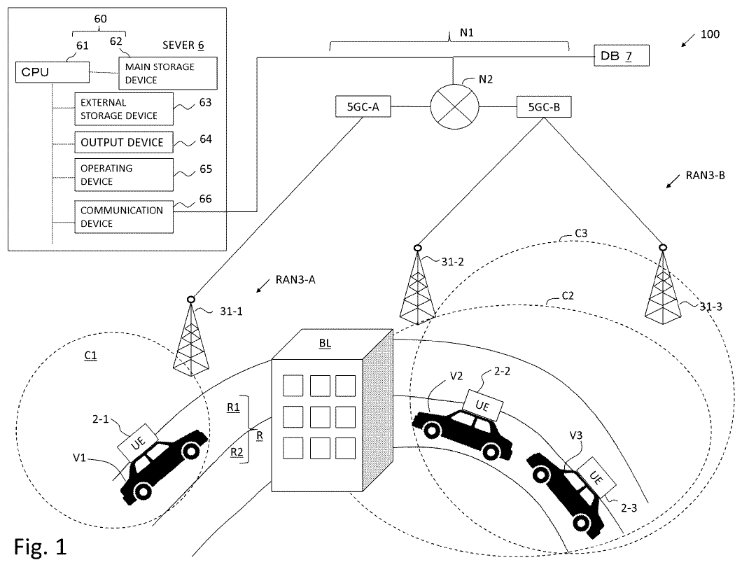

Hereinafter, with reference to the drawings, a management apparatus, an information system, and an information processing method of one embodiment will be described. The management apparatus is exemplified by 5GC-A or 5GC-B (see FIG. 1). In the present embodiment, the management apparatus acquires, in response to a request from an information processing apparatus (server 6) connected to the network, movement information related to the movement of a plurality of vehicles in which any of the plurality of user devices (UE 2) within a predetermined range exists in the vehicle. Then, the management apparatus provides the acquired movement information to the information processing apparatus (server 6). Here, the predetermined range is exemplified by a cell, a list of cells, or the like, and is set to a range close to the local Protocol Data Unit Session Anchor (PSA) UPF. For this reason, the management apparatus can provide movement information to the information processing apparatus with low latency. As a result, the information processing apparatus can acquire movement information with low latency and notify the user device of the processing result. Further, the information processing apparatus and the management device can perform efficient processing by limiting the processing target to a plurality of user devices within a predetermined range. Note that the information processing apparatus may extract and group a plurality of user devices within the predetermined range, and specify a plurality of user devices grouped into the management device in the above request. Further, the management device may receive the above predetermined range designation in the above request and extract a plurality of user devices within the predetermined range.

### (System Configuration and Application Examples)

FIG. 1 is a diagram illustrating an information system 100 of the present embodiment. The information system 100 includes user equipment (hereinafter referred to as UE 2-1 to UE 2-3), a server 6, a database (hereinafter referred to as DB 7), and a network N1. UE 2-1 to UE 2-3 are collectively referred to as UE 2. Here, the number of the UE 2 is not limited to three. Further, the UE 2, the server 6, and the DB 7 are connected by network N1.

The network N1 includes a wireless network and a wired network. That is, the network N1 includes, for example, a mobile communication system such as LTE (Long Term Evolution), a fifth-generation generation mobile communication system (5G), and a sixth-generation mobile communication system (6G), a wireless LAN (Local Area Network), and the like. Further, the network N1 may include a public network such as the Internet.

In FIG. 1, two 5G Cores (hereinafter referred to as 5GC-A and 5GC-B) and a radio access network (hereinafter referred to as RAN 3-A and RAN 3-B) are illustrated as mobile communication systems. 5GC-A and 5GC-B are connected, for example, by network N2. The network N2 is, for example, a wired public network. Further, RAN 3-A includes a base station 31-1, and RAN 3-B includes base stations 31-2 and 31-3. 5GC-A and 5GC-B are collectively referred to as 5GC. However, in the information system 100, 5GC is not limited to two. Here, 5GC-A and 5GC-B are each managed and provided by different mobile network operators.

The server 6 is an example of information processing apparatus and is a computer. However, the server 6 may be referred to as an MEC server. In the present embodiment, the server 6 works with UE 2, for example, augmented reality (AR), Mixed Reality (MR), Virtual Reality (VR) and other Cross Reality (Extended Reality) (XR) environments.

The server 6 includes a central processing unit (hereinafter referred to as the CPU 61), a main storage device 62, and an external device, and executes information processing and communication processing by a computer program. The CPU 61 is also referred to as a processor. The CPU 61 is not limited to a single processor and may be a multiprocessor configuration. Further, the CPU 61 may include a graphics processing unit (GPU), a digital signal processor (DSP), and the like.

The CPU 61 executes an executable computer program deployed to the main storage 62 and provides processing for the server 6. The main storage device 62 stores a computer program executed by the CPU 61, data processed by the CPU 61, and the like. The CPU 61 and the main storage device 62 are referred to as the second controller 60.

The external devices include external storage device 63, output device 64, operating device 65, and a communication device 66 is exemplified. The external storage device 63 is used, for example, as a storage area to assist the main storage device 62, and stores a computer program executed by the CPU 61, data processed by the CPU 61, and the like.

The output device 64 is, for example, a display device such as a liquid crystal display or an electroluminescent panel. However, the output device 64 may include a speaker or other device that outputs a sound. The operation device 65 is, for example, a touch panel in which a touch sensor is placed on the display of the output device 64. The communication device 66 accesses network N1 and the like, and communicates with a computer or the like connected to network N1, etc.

However, the server 6 is not limited to a single computer exemplified in FIG. 1. The server 6 may be a system in which a plurality of computers work together by a network N1 or the like to execute processing with virtualized resources, for example, a cloud environment.

As shown in FIG. 1, the server 6 is connected to both 5GC-A and 5GC-B via network N2. The server 6 can communicate with the UE 2-1 in the cell C1 formed by the base station 31-1 by 5GC-A and RAN3-A. Further, the server 6 can communicate with both UE 2-2 and UE 2-3 in the cell C2 formed by the base station 31-2 by 5GC-B and RAN 3-B. Similarly, the server 6 can also communicate with both UE 2-2 and UE 2-3 in the cell C3 formed by the base station 31-3 by RAN3-B. 5GC-A and 5GC-B are examples of management devices. The hardware configuration of 5GC-A and 5GC-B is also the same as server 6.

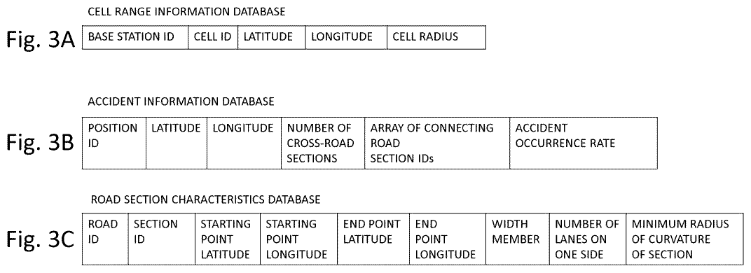

The DB 7 includes a cell range information database, an accident information database, and a road section characteristics database (FIGS. 3A-3C). The DB 7 provides these information to the server 6. The hardware configuration of the DB7 is the same as the server 6. In FIG. 1, the DB 7 is described separately from the server 6. However, the DB 7 and the server 6 may be integrated, or it may be built on the system of a common cloud environment.

The UE 2 is, for example, an example of a user device, and is an in-vehicle device called In-Vehicle Infotainment (IVI), a smartphone, or the like. The hardware configuration of the UE 2 differs from the server 6 in the scale of the hardware, physical dimensions, and the like. However, the hardware configuration of the UE 2 is logically the same as that of the server 6, and includes a processor, memory, wireless communication device, and the like. As shown in FIG. 1, the UE 2-1 to the UE 2-3 are mounted on vehicles V1 to V3, respectively.

In FIG. 1, the vehicle V1 is traveling in lane R1 of the road R toward a curve where the building BL exists in the direction opposite the vehicle V2 and the vehicle V3. Further, the vehicleV2 and the vehicleV3 are traveling in lane R2 toward a curve where a building BL exists in the direction opposite the vehicleV1. That is, the lane R1 and the lane R2 are lanes in which the driving directions of the vehicle V1 and the like face each other in the road R.

The server 6 works with at least one of 5GC-A and 5GC-B to detect an intrusion of the UE 2 or the like into a predetermined area exemplified by cells C1 to C3, etc. The predetermined region can be said to be an example of the predetermined range. The predetermined area is not limited to cells C1 to cells C3 and the like. The predetermined area may include one or more cells, called a tracking area (TA). Further, the predetermined area may be a set of cells indicated by a list of cells or a list of TAs. Further, the predetermined area may be specified in a list of nodes of the RAN 3, for example, one base station 31 or a plurality of base stations 31. Further, the predetermined area may be specified in a specific Local Area Data Network (LADN), or may be specified by one or more slices in a 5G network or the like.

When the server 6 is notified by 5GC that the UE 2 has entered the predetermined area, the server 6 adds the UE 2 that detected the intrusion to the UE 2 group and targets management. Then, the server 6 is notified by the 5GC of the movement information of each UE 2 within the predetermined area. The movement information may include, for example, at least one of the geographical locations (eg, latitude, longitude) of the UE 2, the movement speed, the direction of movement, acceleration, and the like.

The 5GC including the base stations 31-1 to 31-3, etc. specifies the position of the UE 2 when exchanging and receiving signaling messages with the UE 2. For example, in FIG. 1, the base stations 31-2 and 31-3 can communicate with both the UE 2-2 and the UE 2-3, respectively. Therefore, the 5GC-B can measure the positions of the UE 2-2 and UE 2-3 by the principle of triangulation by the base stations 31-2 and 31-3.

That is, the base stations 31-2 and 31-3 may detect, for example, the angle of the transmitting beam (or receiving beam) used during signaling. Then, the 5GC-B extends a straight line corresponding to the transmission beam (or reception beam) from the positions of the base stations 31-2 and 31-3, and the position of the intersection of these straight lines is the position of the UE 2. Then, 5GC-B applies the principle of triangulation from the positional relationship between the base station 31-2, 31-3 and the UE 2, for example, and measures the distance from the base station 31-2, 31-3 to the UE 2, the geographical position (latitude, longitude) of the UE 2, and the like. Further, from the change in the position of the UE 2 over time, the 5GC-B specifies the movement speed and movement direction of the UE 2. Further, from the change in the movement speed of the UE 2 over time, the 5GC-B identifies the acceleration of the UE 2.

Further, 5GC-A and 5GC-B may use the downlink transmission wave from the base station 31-2 or the base station 31-3 in the same principle as the radar. That is, 5GC-A and 5GC-B measure the distance to the UE 2, the current geographical position (latitude, longitude), movement speed, movement direction, acceleration, and the like based on the transmitted wave reflected from the UE 2 or the reflected wave reflected from the vehicle V1 or the like in which the UE 2 exists in the vehicle.

Note that the base stations 31-2, 31-3, and the like may be used in combination with measurement by signaling messages and measurements by reflected waves. For example, the base stations 31-2, 31-3, etc. may roughly specify the position of the UE 2 by signaling message, and measure the position of the UE 2 from the reflection on the transmitted wave by improving the accuracy in real time. The server 6 acquires information related to the position or movement of the UE 2 as described above from the 5GC. Note that FIG. FIG. 1 is an example, and the base station that performs the above triangulation processing is not limited to the base station 31-2 and 31-3.

However, the server 6 may acquire movement information of the UE 2 and vehicle characteristic information such as the vehicle V1 in which the UE 2 exists in the vehicle from the UE 2. For example, when the vehicle V1 in which UE 2-1 exists in the vehicle enters cell C1, which is an example of the predetermined region, 5GC-A establishes a PDU session with the UE 2. At this time, 5GC-A sets a Domain Name System (DNS) resolver or DNS server to the UE based on the cell C1 containing the location of the UE 2-1.

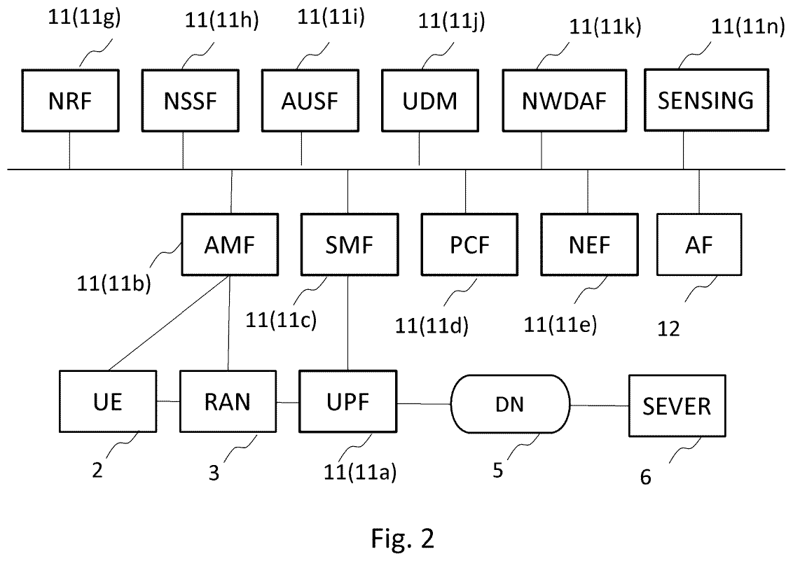

Then, in response to a DNS query from UE 2 to a DNS resolver or a DNS server, the server 6 that is close to both the predetermined region (eg, cell C1) and UPF 11a (see FIG. FIG. 2) is determined. That is, the UPF 11a is preferably a so-called local PSA UPF. The local PSA UPF is selected by the SMF 11c of the 5GC when the UE 2 establishes a PDU session over the 5G network.

The UE 2 accesses the determined the server 6 through the UPF 11a of the base station 31-1 and 5GC-A. For example, the UE 2 may transmit movement information and vehicle characteristic information of the vehicle V1 to the server 6, and request information such as the possibility of contact with other vehicles V2, V3, and the like existing in the vicinity.

Now, suppose that the predetermined area is a geographical area including cells C1 to C3. Then, the server 6 collects movement information and vehicle characteristic information from other UEs 2-2, UE 2-3, and the like that have entered the cells C2, C3, and the like, for example. The server 6 may collect movement information from 5GC-B, UE 2-2, UE 2-3, and the like. The server 6 further acquires road characteristic information (hereinafter referred to as road characteristic information) on which the vehicle V1 or the like travels from the DB 7. Then, the server 6 executes the following process based on the acquired information.

For example, the server 6 detects a plurality of vehicle V1 to V3 that are located within a predetermined distance from each other and are traveling in different directions (also referred to as opposing directions). Then, for each of the detected plurality of vehicle V1 to V3, the server 6 predicts the trajectory of the path, the trajectory of the vehicle width, the possibility of contact with each other, and the like based on the position, vehicle speed, body structure, driving direction, steering information, and the like. Then, the server 6 notifies the UEs 2-1 to 2-3 existing in the vehicles V1 to V3 of the predicted result. The server 6 predicts the possibility of contact or collision by exchanging information with UEs 2-1 to 2-3 and the like as described above, and presents a warning to the driver regarding the position of possible contact or collision via UEs 2-1 to 2-3.

### (Network Example)

FIG. 2 illustrates components (constituent elements) constituting a fifth-generation mobile communication system (also referred to as a 5G network or 5GNW) in the network N1. Here, in the present embodiment, the components of 5GC are collectively referred to as Network Function (hereinafter referred to as NF 11), and individually referred to as NEF 11e and the like. In FIG. 2, each component is denoted by an individual numeral in ( ) along with a generic numeral. Among the components of FIG. 2, configurations other than SENSING 11n are defined, for example, in 3GPP (registered trademark) TS23.501, and the description thereof is omitted. DN 5 is a data network (Internet, etc.) outside 5GC. For example, the server 6 is connected to the DN 5. The server 6 may be 5GC AF12. The RAN (Radio Access Network) 3 is an access network to the 5G core network (5GC). The RAN 3 is configured by a base station 31 (gNB).

The SENSING 11n collects information from the UE 2 or other external system, analyzes the collected information, and provides the analysis results to other the FN 11, the UE 2, the AF 12, or other external system (the DN 5, etc.). However, instead of the SENSING 11n, the NWDAF 11k may perform the processing of the SENSING 11n. In the following embodiment, it is described that the NWDAF 11k performs the processing of the SENSING 11n. NWDAF11k is an example of the controller. However, the SENSING 11n may execute the process as a controller.

### (Example Data)

FIGS. 3A-3C illustrate each database included in the DB 7. In the examples of FIG. 3A-3C, the DB 7 includes a cell range information database (FIG. 3A), an accident information database (FIG. 3B), and a road section characteristics database (FIG. 3C). In FIGS. 3A-3C, each database record is illustrated with tabular rows. However, the data stored in the DB 7 may be described in the form of, for example, keywords=parameters.

Each record in the cell range information database includes a base station Identifier (ID), a cell ID, a latitude, a longitude, and a cell radius. The base station ID is identification information that uniquely identifies the base station 31. The cell ID is identification information that uniquely specifies the cell C1 or the like provided by the base station 31. However, either the base station ID or the cell ID may be omitted from the record in the cell range information database. The latitude and longitude are, for example, the latitude and longitude at which the base station 31 is located. The cell radius is the radius of the cell C1 etc. provided by the base station 31.

The cell range information database provides the server 6 with information on the geographical range covered by the cell C1 and the like of each base station 31. For example, the server 6 can identify a base station 31 that forms a cell C1 and a cell C1 that include an accident-prone position based on the latitude and longitude of the accident-prone position.

The record of the accident information database includes a position ID, latitude, longitude, the number of cross-road sections, an array of connecting road section IDs, and an accident occurrence rate. The position ID is identification information that uniquely identifies the position where the accident occurred. Latitude and longitude are the latitude and longitude of the position specified by the position ID.

The number of cross-road sections is the number of road sections connected to the position specified by position ID. A road section is a section of a road divided into multiple sections. The road section is, for example, a part of the road divided at a bend in the road, such as an intersection, an L-shape, a V-shape, etc. The road section is defined in the road section characteristics database.

For example, when the position is a bend point of a road such as an L-shaped or a V-shape, the number of cross-road sections is 2. In three-way junctions such as Y-shaped and T-shaped, the number of cross-road sections is three. In the case of a four-way road, a five-way road, a six-way junction, etc., in which the road is divided into four, five, and six roads at position, the number of cross-road sections is 4, 5, and 6, respectively. The number of cross-road sections may be 7 or more.

The array of connecting road section IDs is an array whose elements are road IDs and section IDs that specify road sections that are connected to a point specified by a point ID. For example, when the position is a bend point of a road such as an L-shaped or a V-shaped, the array of road section IDs to be connected stores two sets of road IDs and section IDs that specify two road sections connected at the position. When the position is a three-way junction or more, the array of road section IDs to be connected similarly stores the road ID and the section ID by the number of pairs corresponding to the number of cross-road sections.

The accident incidence rate is the incidence rate of traffic accidents at the position specified by the position ID. There is no limit to the definition of incidence. The incidence rate is the number of traffic accidents during a predetermined period. The predetermined period is, for example, one year. The incidence rate may be obtained by converting the number of traffic accidents in the past multi-year into the number of occurrences in the predetermined period by statistical processing. For example, the DB 7 may acquire the number of accidents at each position from information published on the Internet and update the data of the accident information database.

Examples of the information published on the Internet include intersection accident information of each prefecture provided by the General Insurance Association of Japan and an accident risk location search map provided by the Ministry of Land, Infrastructure, Transport and Tourism. However, in these information, the position is exemplified by an intersection name, a position name, and the like. Therefore, the DB 7 may separately maintain a dictionary of latitude and longitude corresponding to the intersection name, position name, and the like. Then, the DB 7 may set the latitude and longitude corresponding to the position ID, the intersection name, the position name, and the like in each information published on the Internet, construct an accident information database, and update it periodically.

In addition, the accident risk area search map provided by the Ministry of Land, Infrastructure, Transport and Tourism does not include the number of accidents, but only dangerous position. Therefore, the DB 7 may set the accident incidence rate at the position based on the accident hazard location search map to, for example, the maximum value of the accident incidence rate of the accident information database. In this case, the DB 7 may provide all data based on the accident risk location search map to the server 6. However, based on the data processed by the server 6 in the past, the warning, contact, and collision history may be accumulated on the DB 7, and the accident-prone position may be identified by statistical processing, and stored together with the accident occurrence rate.

The road section characteristics database has the characteristics of each road section. The server 6 acquires information on the road section characteristics database and predicts the possibility of contact with a plurality of vehicle V1 to V3 traveling in opposite directions on the road section toward the accident occurrence position.

Each record in the road section characteristics database includes a road ID, a section ID, a starting point latitude, a start point longitude, an end point latitude, an end point longitude, a width member, the number of lanes on one side, the minimum radius of curvature of the section, and the like. The road ID uniquely identifies the road, and the section ID is identification information that uniquely identifies the section on the road.

The starting point latitude, the start point longitude, the end point latitude, and the end point longitude are the latitude and longitude of the two endpoints (start point and end point) of the road section, respectively. There is no limitation as to which of the two endpoints is the starting or ending point. The width is the width of the road, and is the width of not only the roadway and sidewalk, but also the entire road structure, including the shoulder, tree planting zone, median belt, etc. The number of lanes on one side is the number of lanes on each side of the road section. The minimum radius of curvature of the section is the minimum value of the radius of curvature of the road in the road section.

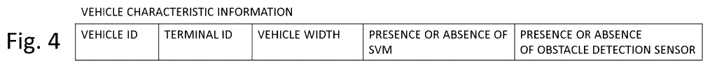

FIG. 4 illustrates an example of the configuration of the vehicle characteristic information. When the UE 2 connects to the server 6 and requests neighboring vehicle information, the UE 2 provides the server 6 with vehicle characteristic information such as the vehicle V1 in which the UE 2 exists. However, the server 6 may acquire vehicle characteristic information in advance from the UE 2 or the like existing in the vehicle V1 and store it in the DB 7.

The vehicle characteristic information includes vehicle ID, terminal ID, vehicle width, presence or absence of Surround View Monitor (SVM), and presence or absence of obstacle detection sensor. The server 6 acquires vehicle characteristic information and predicts the possibility of contact with a plurality of vehicle V1 to V3 traveling in opposite directions toward the accident occurrence position.

The vehicle ID is an ID in which the server 6 uniquely specifies the vehicle V1 and the like. The server 6 may assign a vehicle ID when the UE 2 first accesses the server 6 and requests neighboring vehicle information. The terminal ID is an ID of the UE 2, for example, a telephone number. The width of the vehicle is the width of the vehicle V1 etc. on which the UE 2 is mounted (the length in the direction perpendicular to the moving direction).

The presence or absence of an SVM is information indicate whether or not the vehicle V1 or the like is equipped with an SVM. SVM is also known as View Around Monitor (VAM). The presence or absence of an obstacle detection sensor is information regarding whether or not the vehicle V1, etc. is provided with sensors for detecting obstacles at the four corners of the vehicle V1, etc.

### (Processing Example)

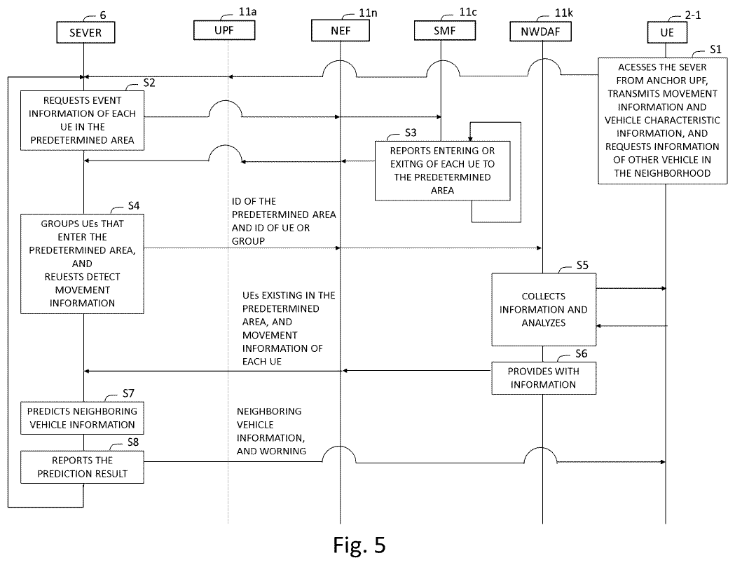

FIG. 5 is a sequence diagram illustrating the processing of each component in the information system 100. In this process, for example, the UE 2-1 existing in the vehicle V1 accesses the server 6 from the UPF 11a of 5GC. The server 6 has an IP address determined by a DNS resolver or DNS server configured by the Edge Application Server Discovery Function (EASDS) of 5GC and selected based on the location of the UE 2.

Further, the UPF 11a is one of the distributed anchor points, and when the UE 2 establishes a PDU session via the 5G network, it is selected by the SMF 11c as the UPF that exists closest to the position of the UE 2. The UPF 11a is also referred to as the local Protocol Data Unit (PDU) Session Anchor (PSA) UPF. The server 6 is connected to the UE 2 by the UPF 11a, which is a local PSA UPF.

Further, the UPF 11a is an example of an interface on the network that connects the 5GC as the management device and the server 6 as the information processing apparatus. In the present embodiment, the predetermined area can be said to be a range that includes a predetermined geographical range from the position where the interface is installed.

Then, the UE 2-1 transmits movement information and vehicle characteristic information to the server 6 via the UPF 11a (local PSA UPF), and requests information such as other vehicle V2 running in the neighborhood (S1).

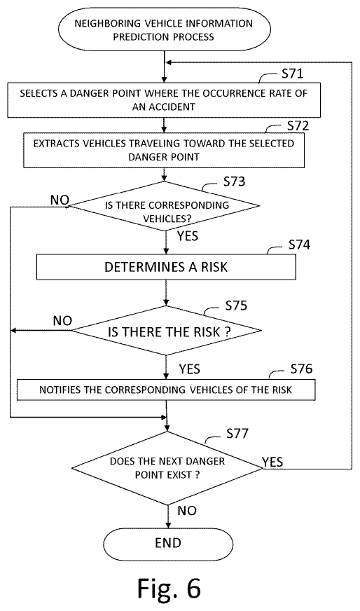

In response to S1's request, the server 6 requests SMF 11c via NEF11n of 5GC to specify the predetermined area and report event information of each UE 2 in the predetermined area (S2). Here, the event information includes, for example, entry into the predetermined area of each UE 2, exit from the predetermined area, and the like. In this process, the server 6 selects a danger position where the occurrence rate of an accident is equal to or greater than the standard value from the accident information database of the DB 7. The server 6 may then set, as the predetermined area, a geographical range that includes danger points located within a predetermined size (e.g., the radius of a circle) from the geographical location (latitude, longitude) where the server 6 is installed or the geographical location (latitude, longitude) where the UPF 11a is installed. When the server 6 is installed in the same data center or the like as the data center in which the UPF 11a is installed, the server 6 can use the same geographical location as the server 6 as the location of the UPF 11a. For example, the geographic location of the UPF 11a may be registered as a system parameter that is set in a program for causing the server 6 to execute the process of FIG. 5 (and FIG. 6) and that the server 6 can refer to. Alternatively, the operator of the server 6 may store the geographic location of the UPF 11a in the main storage device 62 or the external storage device 63. Then, the server 6 may read the geographical location of the UPF 11a from the main storage device 62 or the external storage device 63 when executing this program.

The predetermined size (for example, the radius of the circle) may be set by the administrator of the server 6, for example, as a system parameter of the server 6. The server 6 may determine the predetermined area by referring to the cell range information database of FIG. At this time, for example, the server 6 may determine a range specified by a cell ID that identifies a single cell that covers a geographical range that includes a danger point or a range specified by a list of multiple cell IDs as the predetermined area. However, the predetermined area may be specified based on TA, a list of TAs, a list of nodes such as the base station 31, information for identifying a LDN, information for identifying a slice of the 5G network, and the like.

When an event (e.g., entering or exiting) of each UE 2 to the predetermined area occurs, the SMF 11c receiving the request of S2 reports the event to the server 6 via NEF 11n (S3). In the present embodiment, the SMF 11c repeatedly executes the process of S3 until a stop request is received from the server 6, and reports the event to the server 6 each time an event occurs. However, the SMF 11c may respond once to one request of the server 6 by S2. That is, the request of S2 may be made by either the Subscribe/Notify method or the Request/Response method.

In response to S3 (S4), the server 6 groups UEs 2 that enter the predetermined area. If a group for the UEs 2 that have entered the predetermined area has not yet been created, the server 6 creates a new group. The server 6 then includes the UE 2, which has been notified by the response of S3 that it has entered the predetermined area, in the newly created group. Further, when a group of the UEs 2 existing in the predetermined area has already been created, the server 6 includes the UE 2 that has been notified that it has entered the predetermined area, by the response of S3, to the existing group. Then, the server 6 requests the NWDAF 11k to detect movement information within the predetermined area for the UE 2 included in the group via the NEF 11n (S4). In the request of S4, the server 6 specifies, for example, information specifying the predetermined area (such as a cell ID) and a list of identification information of the UEs 2 included in the group.

However, the server 6 may request the NWDAF 11k to detect the movement information within the predetermined area by omitting the list of identification information of the UE 2 that is the target for detecting the movement information. If the list of identification information of UE 2 is omitted, the NWDAF 11k may acquire identification information of the UE 2 currently existing in the predetermined area from the SMF 11c or AMF 11b, for example. That is, the NWDAF 11k as the controller receives a request from the server 6 connected to the network N1 and extracts and groups a plurality of UE 2 included in the predetermined range (TA, cell, list of TAS, list of cells, LADN, slice, etc.). For example, the NWDAF 11k may acquire from the AMF 11b a plurality of UE 2 included in the predetermined range (TA, cell, list of TAs, list of cells, LADN, slice, etc.).

Upon receipt of S4's request, the NWDAF 11k collects information related to the movement of the UE 2 specified in S4 or the UE 2 existing in the predetermined area, and analyzes the collected information (S5). For example, as described in FIG. 1, NWDAF11k can measure the distance from base stations 31-2, 31-3 to UE 2 and the geographical location (latitude, longitude) of UE 2 based on the positional relationship between base stations 31-2, 31-3 and UE 2 by applying the principle of triangulation. Further, from the change in the position of the UE 2 over time, the NWDAF 11k may specify the movement speed and movement direction of the UE 2. Further, from the change in the movement speed of the UE 2 with the passage of time, the NWDAF 11k may specify the acceleration of the UE 2.

Here, the NWDAF 11k may acquire the position information of the UE 2 in cooperation with the Location Service (LCS) of the 5GC. The LCS acquires, for example, the position information of the UE 2 from the AMF 11b. In addition, LCS acquires the position information of the UE 2 based on the local Internet Protocol (IP) address of the UE 2, the Service Set Identifier (SSID) of the access point of the wireless Local Area Network (LAN), and the like. Further, the LCS may communicate with the UE 2 existing in the predetermined area, acquire position information, time information, and the like positioned by the Global Positioning System (GPS), the Global Navigation Satellite System (GNSS) mounted on the UE 2, and provide it to the NWDAF 11k.

However, the NWDAF 11k may acquire information related to movement from an external server equipped with an external AF or the like connected to DN5 or the like outside the 5GC, or from the AF 12 in the 5GC. Further, the NWDAF 11k may acquire position information and time information (time stamp) of the UE 2 in the predetermined area from the AF 12 or an external server multiple times, and calculate the speed, acceleration, direction of movement, and the like of the UE 2. The AF 12 or the external server may communicate with, for example, the UE 2 existing in the predetermined area, acquire position information, time information, and the like positioned by GPS, GNSS, and the like mounted on the UE 2, and provide it to the NWDAF 11k.

Then, the NWDAF 11k provides the server 6 with information obtained as a result of the analysis via the NEF 11n (S6). However, NWDAF11k may respond once to one request of the server 6 by S4. Further, after receiving one request of the server 6 by S4, the NWDAF 11k may repeat until a stop request is received from the server 6 and respond to the server 6 with information. That is, the request of S4 may be made by either the Request/Response method or the Subscribe/Notify method.

The server 6 predicts neighboring vehicle information based on the movement information of each UE 2 received from the NWDAF11k via the NEF11n (S7). Here, the neighboring vehicle information may include contact between vehicles V1, V2, and the like passing each other in an opposing direction in the predetermined area, the possibility of occurrence of other traffic accidents, and the trajectory of movement of passing vehicles V1, V2, etc.

Then, the server 6 notifies the UE 2-1 that made the request in S1 and the other UEs 2 registered in the group of the prediction result (S8). The prediction results include contact between vehicles, the possibility of other traffic accidents, information on position where traffic accidents are likely to occur, and the like. If the probability of occurrence of a traffic accident is higher than the standard value, the server 6 may notify the UE 2-1 or the like that requested S1 of a warning together with the prediction result. Further, if the possibility that the UE 2-1 that made the request of S1 is involved in a traffic accident or the like is lower than the standard value, the server 6 may notify the UE 2-1 that requested S1 to that effect.

In the processing of S8, the server 6 may report the prediction result by limiting it to the UE 2-1 and the UE 2-2 existing in vehicles V1, V2, etc., which are likely to cause a traffic accident. Further, the server 6 may also notify the prediction result to another vehicle V3 or the like heading to a position where there is a high possibility of a traffic accident. After notification at S8, the server 6 returns to S2 and continues processing. The server 6 may repeat the process of FIG. 5 until the request is canceled (processing stopped) is notified by the UE 2-1. However, the server 6 may respond once to one request from UE 2-1 in S1 and terminate the process.

FIG. 6 is a flowchart illustrating details of the neighboring vehicle information prediction process (S7 in FIG. 5) and the notification process of the prediction result (S8 in FIG. 5). In this process as well, the server 6 selects a danger point where the occurrence rate of an accident is equal to or greater than the standard value from the accident information database of the DB7 (S71). The danger point selected in S71 is the same as the danger point selected in the S2 process of FIG. 5.

Then, the server 6 extracts a group of vehicles, such as the vehicles V1, V2, etc., traveling in opposite directions each other toward the selected danger point, based on the movement information obtained from the NWDAF 11k (S72). Note that the server 6 may issue a warning in advance to the extracted vehicle group that it is heading toward an accident-prone location.

Then, when there is a plurality of corresponding vehicles V1, V2, etc. (YES in S73), the server 6 calculates the movement trajectory of the corresponding vehicles V1, V2, etc., and determines the possibility (risk) of a traffic accident such as contact between vehicles (S74). More specifically, the server 6 identifies a road R on which the corresponding vehicles V1, V2, and the like travel. Then, the server 6 acquires the characteristics of the road section connected to the danger point from the road section characteristic database of DN7. Further, the server 6 calculates the movement trajectories of each vehicle V1 and V2 based on the vehicle characteristic information (FIG. 4) of each vehicle V1 and V2. Then, the server 6 calculates the possibility of contact of the vehicles V1 and V2 based on the vehicle width of the vehicles V1 and V2, the width of the road, the number of lanes on one side, the minimum radius of curvature of the section, and the like.

For example, when the sum of the widths of both vehicles V1 and V2 traveling toward the danger point is greater than the width of the road, the server 6 simply calculates the possibility of contact as a standard value or higher (eg, 100%). Further, for example, the server 6 may perform regression analysis based on case data of past traffic accidents. That is, the server 6 uses explanatory variables such as the vehicle width, the presence or absence of SVM, the presence or absence of an obstacle detection sensor, the width of the road, the number of lanes on one side, the minimum radius of curvature of the section, and the like of each corresponding vehicle from the case data. Then, the server 6 may create an experimental equation for regression analysis using the possibility of contact as an dependent variable. Then, the server 6 inputs the vehicle characteristic information (FIG. 4) of the corresponding vehicles V1 and V2 and the data of the road section characteristic database of the road section on which the vehicles V1 and V2 are traveling into the created experimental formula, and calculates the possibility of contact.

In addition to the possibility of contact, the server 6 may predict whether or not the vehicles V1 and V2 will protrude into the other lane. For example, based on the above case data, the server 6 uses vehicle widths such as vehicles V1 and V2, speeds of vehicles V1, V2, etc., road width, number of lanes, and minimum radius of curvature as explanatory variables. Then, the server 6 may set an experimental formula for regression analysis using the possibility of overstepping into the other lane as a dependent variable based on past case data. Then, the server 6 may input the vehicle characteristic information of the vehicles V1 and V2 and the characteristics of the road section on which the vehicles V1 and V2 travel in an experimental formula, and calculate the possibility of protruding into the other lane.

Then, server 6 determines whether there is the risk determine (S75). For example, the server 6 may determine that there is a risk when the possibility of contact or the like exceeds the standard value with a reference value of 50%.

If there is the risk in the judgment of S75, server 6 notifies the corresponding vehicles V1, V2, etc. of the risk (S76). In the process of S76, the server 6 may instruct UE 2-1, UE 2-2, and the like to display the possibility of contact, danger, and the like XR based on the movement trajectory of each vehicle V1, V2, etc. Then, the server 6 proceeds to the process of S77. Further, when the determination of S73 or the determination of S75 is NO, the server 6 proceeds to the process of S77. Then, the server 6 determines whether or not the next danger point exists (S77). If the next danger point exists, the server 6 returns the process to S71. If the following danger position does not exist, server 6 terminates the process.

### (Embodiment Effect)

As described above, in this embodiment, the NWDAF11k as a control unit receives a request from the server 6 connected to the network N1 and acquires movement information regarding the movement of multiple vehicles V1-V3 in which any of multiple UE 2 within the predetermined range (TA, cell, list of TAS, list of cells, LADN, slice, etc.) exists. Further, the NWDAF 11k provides the acquired movement information to the server 6. With such processing, the NWDAF 11k can limit the processing target to the UE(s) 2 included in the predetermined range, that is, the UE(s) 2 existing in the predetermined region. As a result, the server 6 can efficiently provide information on the movement of a moving object such as the vehicle V1, as the controller. In this case, the server 6 may extract and group the UEs 2 existing in the predetermined area, and specify the extracted and the grouped UEs 2 in the request to NWDAF 11k. Further, the NWDAF 11k may receive a designation of the predetermined region from the server 6 and extract the UE 2 existing in the predetermined region.

In the present embodiment, the information system 100 includes a 5GC as an example of the management apparatus and a server 6 as an example of the information processing apparatus, including an NWDAF 11k as an example of the first controller. Then, in the server 6, the second controller 60 executes a prediction process for the possibility of contact between at least two UEs 2 among the plurality of UE 2 based on the movement information provided by the NWDAF 11k. Further, the server 6 transmits the results of the prediction process to at least two UE 2 of the plurality of UE 2. For this reason, the server 6 can execute prediction processing using information on the movement of a moving object such as a vehicle from 5GC.

Here, the server 6 is called MEC server, and there is the UE 2 to be processed connected to the 5GC via a local PSA UPF installed near the predetermined area. That is, in the present embodiment, the UPF 11a, which is a local PSA UPF, is an example of an interface on the network N1 that connects 5GC as a management device and the server 6 as an information processing device. And the predetermined area can be said to be a range that encompasses a predetermined geographical area from the location where the interface is installed. Therefore, the server 6 collects information from 5GC NWDAF11k, etc., with an extremely small latency, and the UE 2 can be communicated to. As a result, the possibility of suppressing the occurrence of a traffic accident exemplified by contact with a vehicle V1, V2, or the like can be increased.

In the present embodiment, the UE 2 is, as an example, an in-vehicle device. As a prediction process, the server 6 extracts a danger point where the frequency of occurrence of traffic accidents exceeds the standard value from the geographical range included in the predetermined range. Then, the server 6 acquires the vehicle characteristics information including the width of a plurality of vehicles V1, V2, etc. traveling toward the extracted danger point and traveling in opposite directions each other, and the road characteristics information including the width of the road on which a plurality of vehicles V1, V2, etc. are traveling. Further, the server 6 estimates the possibility of contact of a plurality of vehicle V1, V2, etc. based on these vehicle characteristic information and road characteristic information. In this way, the information system 100 can extract a danger point in advance, limit the target point of the prediction process, and effectively use computer resources to execute the prediction process.

### (Other Variations)

In the above embodiment, the server 6 executes a information exchange process. In the information exchange process, the server 6 collects vehicle characteristic information from each UE 2, analyzes the degree of risk of traffic accidents, and distributes the analysis results to the UE 2 where the risk of traffic accidents is equal to or greater than the standard value. Further, the server 6 executes an information exchange process for collecting information from a plurality of 5GC-A, 5GC-B, and the like. However, the information exchange in the present embodiment may be executed by direct communication between vehicles by UEs 2-1 to 2-3 mounted on the vehicles V1 to V3 instead of processing by the server 6. For example, direct communication between vehicle is effective when there is no obstacle between vehicles V1 to V3. However, when there is an obstacle such as a building BL at a curve point such as road R as shown in FIG. 1 and direct communication is difficult, indirect communication via the network N1 and the server 6 is effective. Furthermore, by comprise a function on the server 6 for exchanging information between vehicles and performing analysis such as protrusion prediction processing, the load of calculation processing in the UE 2 can be reduced.

Further, the server 6 may mediate and present the actions to be taken to avoid contact or avoid collision with the corresponding vehicles V1 and V2 together with notification of the prediction result of S8 in FIG. With such a mediation process, the server 6 can reduce the possibility of errors in the driver's response of vehicles V1, V2, etc.

Further, the server 6 may acquire movement information of the vehicle Vx not having the function of the present embodiment from the NWDAF 11k and be subject to processing. For example, the NWDAF11k may detect a vehicle Vx in the predetermined area using the principle of radar by a transmitted wave described in FIG. 1. Then, the NWDAF 11k may detect the position of the vehicle Vx, the movement speed, the direction of movement, the acceleration, the vehicle width, and the like, and notify the server 6. Further, the server 6 may acquire the position, movement speed, direction of movement, acceleration, vehicle width, and the like of the vehicle Vx from the vehicle V1 having a function of receiving prediction results from the processing of FIGS. 5 and 6 by connecting them to the network N1.

In addition to the vehicle V1 equipped with the UE 2 or the like connected to the network N1, the server 6 may group the vehicle Vx detected by the radar principle, and execute the prediction process of FIG. 6. Then, the server 6 may notify the vehicle V1 or the like of the prediction result by the processing of FIGS. 5 and 6. Even if the vehicle Vx does not have a function of receiving the prediction result from the processing of FIGS. 5 and 6, if the vehicle Vx has an inter-vehicle communication function, the server 6 may notify the vehicle Vx of the prediction result via the vehicle V1 or the like. For example, the server 6 may calculate the predicted trajectory of the vehicle Vx based on the data obtained by sensing from the vehicle V1. Then, the server 6 may execute information exchange for the vehicle Vx on behalf of the vehicle Vx via the vehicle V1 or the like.

The server 6 may individually identify and extract the vehicle V1 to be processed using encoding by a spatial heavyweight curve with respect to the vehicle V1 subject to processing in FIGS. 5 and 6. By such encoding, the server 6 can effectively extract and process the vehicle V1 or the like existing in the predetermined area in the processing of FIGS. 5 and 6.

### OTHER EMBODIMENTS

The above embodiment is only an example, and present disclosure may be appropriately changed and implemented within the scope of not deviating from the gist. In addition, the processes and means described in present disclosure can be freely combined and implemented as long as no technical contradiction arises. Further, the process described as being performed by one device may be performed by a plurality of devices. Alternatively, the processing described as performed by different devices may be performed by one device. In a computer system, the hardware configuration (server configuration) by which each function is implemented can be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMS, EEPROMs, magnetic cards, flash memories, or optical cards.

What is claimed is:

1. A management apparatus comprising a controller configured to:
acquire, in response to a request from an information processing apparatus connected to the network, movement information related to the movement of a plurality of vehicles in which any of the plurality of user devices within a predetermined range exists in the vehicle, and
provide the acquired movement information to the information processing apparatus.

2. An information system including a management apparatus and an information processing apparatus, wherein
the management apparatus comprises a first controller configured to:
acquire, in response to a request from the information processing apparatus connected to the network, movement information related to the movement of a plurality of vehicles in which any of the plurality of user devices within a predetermined range exists in the vehicle, and
provide the acquired movement information to the information processing apparatus, and
the information processing apparatus comprises a second controller configured to:
execute, based on the movement information, a prediction process for the possibility of contact between the plurality of vehicles, and
transmit the result of the prediction process to at least two user devices among the plurality of user devices.

3. The information system according to claim 2, wherein
the predetermined range encompasses a predetermined geographical range from the position where the interface on the network connecting the management apparatus and the information processing apparatus is installed.

4. The information system according to claim 4, wherein
the second controller, as the prediction process, estimates the possibility of contact between at least two vehicles,
the at least two vehicles are vehicles that travel from a geographical area included in the predetermined range toward a position where the frequency of occurrence of traffic accidents is equal to or greater than the standard value, and that travel in opposite directions to each other, and
the second controller estimates the possibility of contact between at least two vehicles based on vehicle characteristic information including a vehicle width of at least two vehicles and the road characteristic information including a width of a road on which the at least two vehicle travel.

5. An information processing method to be executed by a management apparatus and an information processing apparatus, wherein
the management apparatus
acquires, in response to a request from an information processing apparatus connected to the network, movement information related to the movement of a plurality of vehicles in which any of the plurality of user devices within a predetermined range exists in the vehicle, and
provides the acquired movement information to the information processing apparatus, and
the information processing apparatus
performs a prediction process for the possibility of contact between the plurality of vehicles, and
transmits the result of the prediction process to at least two user devices among the plurality of user devices.
